(19) United States
(12) Patent Application Publication
(10) Pub. No.: US 2025/0091628 A1
(43) Pub. Date: Mar. 20, 2025

(54) Foldable panel cart

(71) Applicant: Nhon Hoa Nguyen, Bankstown (AU)

(72) Inventor: Nhon Hoa Nguyen, Bankstown (AU)

(21) Appl. No.: 18/678,324

(22) Filed: May 30, 2024

Related U.S. Application Data
(60) Provisional application No. 63/469,572, filed on May 30, 2023.

(51) Int. Cl. B62B 3/02; B62B 3/10; B62B 3/16

(52) U.S. Cl. CPC B62B 3/022; B62B 3/108; B62B 3/16

(57) ABSTRACT

A foldable or collapsible panel cart can include a base frame with wheels. The panel cart can include multiple standing frames erected from the base frame. The standing frames can be coupled to the base frame through movable joints, such as rotatable hinges, configured to rotate the standing frames into folded configuration parallel to the base frame. Multiple couplers, such as latches or bolts, can be disposed between the standing frames in upright position and the base frame to secure the standing frames to the base frame in the upright position.

This application claims priority from U.S. Provisional Patent Application Ser. No. 63/469,572, filed on May 30, 2023, entitled “Foldable panel cart”, hereby incorporated by reference in its entirety.

### BACKGROUND OF THE INVENTION

With the advancement of the construction industry, sheet materials are more and more popularly used with increasingly diverse sizes and designs. In order to move large sheets of material, it is necessary to have panel carts having large material erecting frames, which take up large storage area during the transportation and storage of the carts.

Therefore, there is a need for suitable structure of a panel cart, which does not take up a lot of space for storage and transporting.

### SUMMARY OF THE EMBODIMENTS

In some embodiments, the present invention discloses a folded panel cart having a standing or operating configuration and a storage or folded configuration. In the standing configuration, which is configured for supporting and for moving large panels, the panel cart includes standing frames mounted on a base frame configured to support multiple panels. In the storage configuration, the panel cart can be folded flat to reduce area and space. The panel cart in its storage configuration can be configured for stacking.

The foldable or collapsible panel cart can include a base frame with wheels. The panel cart can include multiple standing frames erected from the base frame. The standing frames can be coupled to the base frame through movable joints, such as rotatable hinges, configured to rotate the standing frames into folded configuration parallel to the base frame. Multiple couplers, such as latches or bolts, can be disposed between the standing frames in upright position and the base frame to secure the standing frames to the base frame in the upright position.

This Summary is provided to introduce a selection of concepts in a simplified form that are further described below in the detailed description section. This summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1A-1B illustrate a foldable panel cart in standing configuration and in storage configuration according to some embodiments.

FIGS. 2A-2B illustrate a foldable panel cart configured for transporting panels according to some embodiments.

FIGS. 3A-3B illustrate a stack of foldable panel carts according to some embodiments.

FIG. 4 illustrates elements of a foldable panel cart according to some embodiments.

FIG. 5 illustrates an exploded view of a foldable panel cart according to some embodiments.

FIGS. 6A-6C illustrate a folding operation of connector bars in a foldable panel cart according to some embodiments.

FIGS. 7A-7B illustrate configurations of connector bars in a foldable panel cart according to some embodiments.

FIGS. 8A-8D illustrate a folding operation of standing frames in a foldable panel cart according to some embodiments.

FIGS. 9A-9D illustrate another folding operation of standing frames in a foldable panel cart according to some embodiments.

FIGS. 10A-10D illustrate configurations of a reinforced bar in a foldable panel cart according to some embodiments.

FIGS. 11A-11C illustrate a folding operation of standing frames to form parallel planes according to some embodiments.

FIGS. 12A-12B illustrate configurations of standing frames folding according to some embodiments.

FIGS. 13A-13B illustrate a configuration of a stack support in a base frame according to some embodiments.

FIGS. 14A-14C illustrate flow charts for forming a foldable panel cart according to some embodiments.

FIGS. 15A-15C illustrate flow charts for folding a foldable panel cart according to some embodiments.

FIGS. 16A-16C illustrate configurations of nestable support frames according to some embodiments.

FIGS. 17A-17D illustrate a folding operation for two adjacent support frames according to some embodiments.

FIGS. 18A-18D illustrate a configuration for nesting 4 support frames of a collapsible cart according to some embodiments.

### DETAILED DESCRIPTION OF THE EMBODIMENTS

In some embodiments, the present invention discloses a folded panel cart having a standing configuration for supporting and for moving large panels, together with a storage configuration for the storage and the transportation of the panel cart. In the standing configuration, the panel cart includes standing frames mounted on a base frame configured to support multiple panels, and with the base frame having rolling wheels for moving the panels to places, such as from the factory to the warehouses or to the construction sites. In the storage configuration, the panel cart can be folded flat, e.g., the standing frames can be folded to be substantially parallel to the base frame to reduce area and space. The panel cart in its storage configuration can be configured for stacking, e.g., multiple folded panel carts can be stacked on top of each other for space saving.

The foldable or collapsible panel cart can include a base frame with wheels, such as swivel and non-swivel wheels. The base frame can include slots configured to accept forks of a forklift. The base frame can include multiple beams coupled together, such as welded or bolted together.

The panel cart can include multiple standing frames erected from the base frame, such as standing perpendicular from the base frame. The standing frame can include multiple beams coupled together. The standing frame can be flat, such as a rectangular frame or an A shape frame, e.g., an A-frame.

The standing frames can be coupled to the base frame through movable joints, such as rotatable hinges. The rotatable hinges can be coupled to a bottom portion of the standing frames, with the coupling configured to fold the standing frames, e.g., to rotate the standing frames from an upright position (e.g., a position making an angle larger than zero, such as perpendicular or substantially perpendicular, e.g., 90 degrees or less, 80 degrees or less, or 75 degrees or less) with the base frame to a folded position (e.g., a position substantially parallel to the base frame, such as making an angle less than 10 degrees, less than 5 degrees, or less than 2 degrees with the base frame).

Multiple standing frames can be disposed along a side of the base frame, such as a long side, with each standing frame crossing a short side of the base frame. Multiple hinges, such as rotatable coupling joints, can be disposed at the base of each standing frame, such as at two ends of the base.

Since there is minimum stress on the hinges, the hinges can be simple hinges, such as a pin inserted through holes in both the standing frame and the base frame, which can allow the standing frame to rotate relative to the base frame. Ball bearing can be added for case of rotation.

The standing frames can be folded in two opposite directions, such as half of the standing frames on a left side are folded to the right side, and vice versa. The different direction folding can allow the standing frames, when folded, to stay mostly or all on the top surface of the base frame. The height of the standing frames can be restricted, to minimize a protrusion of the folded standing frame outside of the base frame, such as not protruding outside of the base frame surface. For example, a middle standing frame, e.g., the standing frame at an outermost of a half of the standing frames which is next to another outermost of another half of the standing frames, can be configured so that the height and the position on the base frame are such that the folded middle standing frame is positioned within the base frame.

Multiple couplers, such as latches or bolts, can be disposed between the standing frames in upright position and the base frame to secure the standing frames to the base frame in the upright position. The couplers can be quick couplers, which can enable an operator to quickly couple and uncouple the standing frames with the base frame.

The standing frames can be coupled together, for example, by connector bars, to strengthen the upright position of the multiple standing frames. Before folding the standing frames, the connector bars can be removed, e.g., folding down to be parallel, or substantially parallel, with a plane defined by the standing frames. The folding of the connector bars can be provided by hinges coupled to one end of the connector bars with the standing frames. The opposite end of the connector bars can include couplers for securing the connector bars to the adjacent standing frames. The hinges and couplers securing the connector bars to adjacent standing frames can be similar to the hinges and couplers securing the standing frames to the base frame.

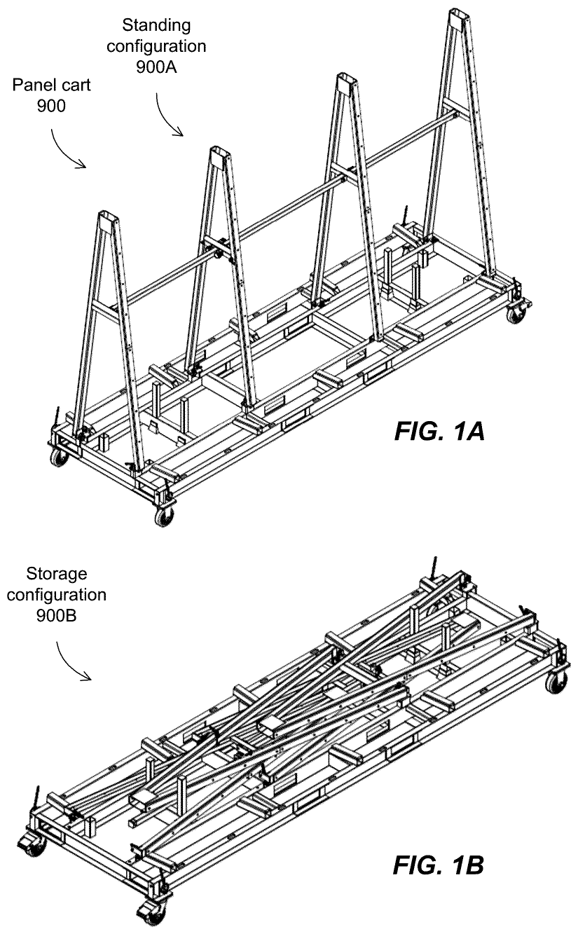

FIGS. 1A-1B illustrate a foldable panel cart in standing configuration and in storage configuration according to some embodiments. FIG. 1A shows a foldable panel cart 900 in a standing configuration 900A for supporting panels for transport. Panels can lean against standing frames on either side of the panel cart 900. FIG. 1B shows the foldable panel cart 900 in a storage or folded configuration 900B for storage or for transporting the panel cart.

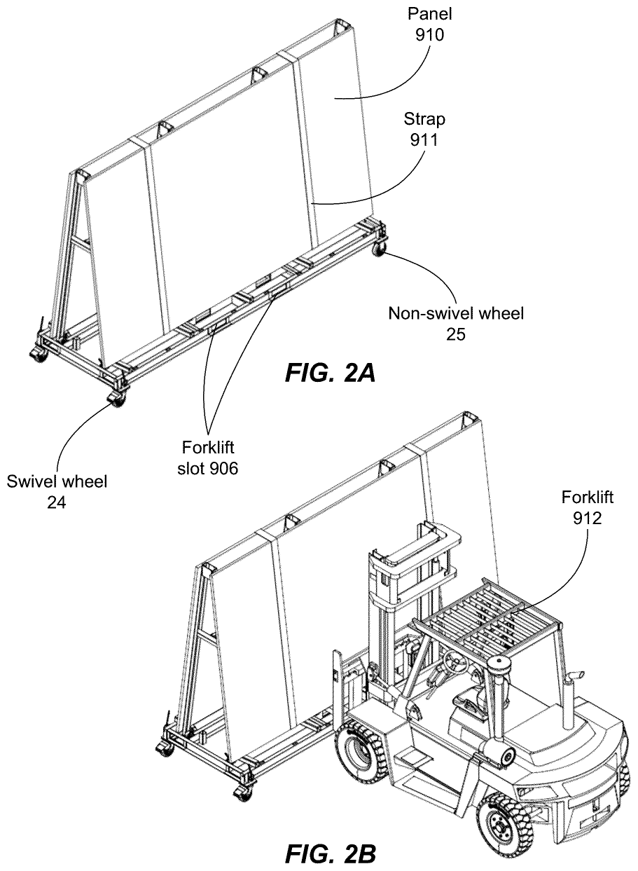

FIGS. 2A-2B illustrate a foldable panel cart configured for transporting panels according to some embodiments. In FIG. 2A, panels 910 can be disposed on the panel cart on both sides of the standing frames erected from a base frame. Straps 911 can be used to secure the panels, such as to secure the panels to the standing frames and to the base frame. The panel cart can have wheels for moving, e.g., for transporting the panels to a destination.

In FIG. 2B, the panel cart with the panels disposed thereon, can be transported by a forklift 912. For example, if there are many panels, the panel cart can be difficult to move. A forklift can lift the whole panel cart together with the panels for transporting to the destination.

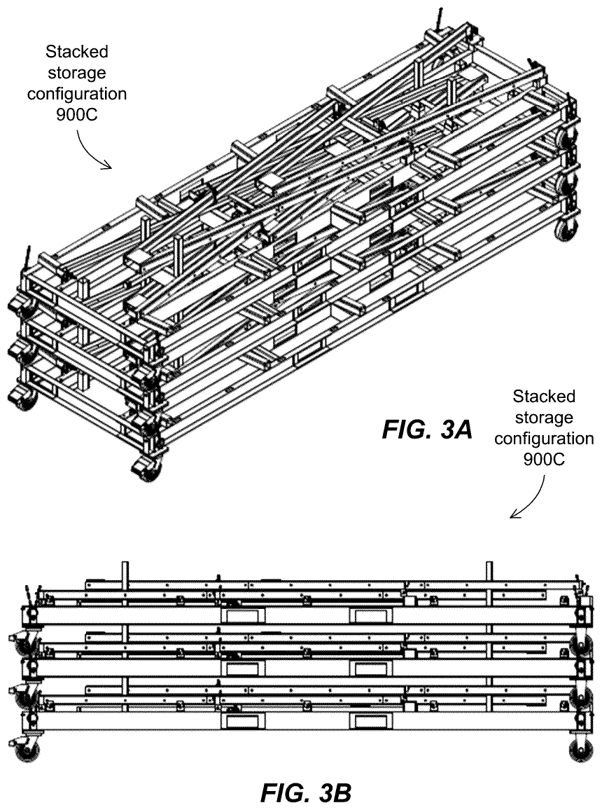

FIGS. 3A-3B illustrate a stack of foldable panel carts according to some embodiments. FIG. 3A shows a perspective view of a stack 900C of foldable panel carts. FIG. 3B shows a side view of the stack of foldable panel carts. The foldable panel carts can be folded flat, e.g., having a height much less than the height of the folded panel cart in the standing configuration. In the storage position, the standing frames can lay flat on the base frame, to provide a space saving storage configuration.

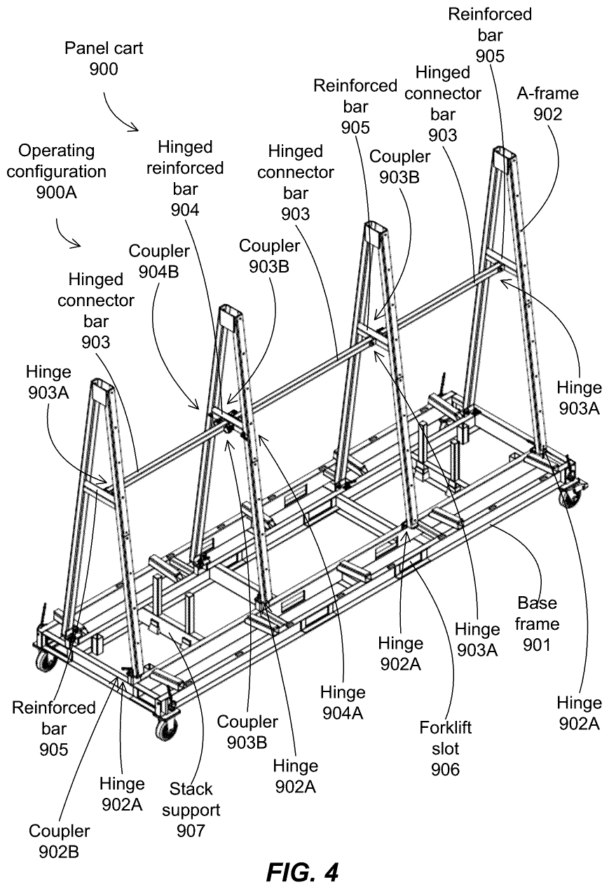

FIG. 4 illustrates elements of a foldable panel cart according to some embodiments. A foldable panel cart 900 can be configured to support panels in an upright or operating configuration 900A, e.g., the panels do not lay flat on the panel cart. Thus, a length of the panel cart is comparable with a length of a panel, and a width of the panel cart can be much smaller than a width of the panel, with a constraint of stability for the panel cart.

The panel cart 900 can include a base frame 901, which can be constructed, for example, from multiple beams coupled together for light weight or from a flat plate having strengthening beams. The base frame can have a shape, such as rectangular or trapezoid, with a long side configured to support a long side of a panel. For example, the length of the base frame can be 5-6 feet, which can be used support panel length of 8 feet with about one foot of panel hanging on each side. The width of the base frame can be designed to keep the base frame stable when supporting multiple panels, which can be 2-3 feet.

The base frame can include forklift slots 906, e.g., opening in the base frame, such as opening in the beams along a length of the base frame. The forklift slots can be configured to accept the forks of a forklift, to allow the forklift to lift and to transport the panel cart, with or without panels strapped thereon.

The base frame can have tilted surfaces on both ends of the frame width, with the tilted surfaces running along the length of the frame. The width of a tilted surface can be less than about a quarter of the frame width, including less than one fifth or one sixth. The tilted surfaces are configured to tilt panels disposed on the tilted surface toward a center of the base frame. The tilted angle can be configured to form a perpendicular angle with beams of the standing frames, such as the legs of the A beams of the standing frames.

Wheels can be installed on a bottom of the base frame for moving the base frame. Different wheel configurations can be used, such as 4 swivel wheels or a combination of 2 swivel wheels and 2 non-swivel wheels on 4 corners of the base frame.

The base frame can include one or more stack supports 907. When the panel cart is in storage or folded configuration 900B, e.g., when the standing frames are folded flat on the base frame, the stack supports can be configured to support the base frame of another folded panel cart disposed on top of the folded panel cart having the stack support.

The stack support 907 can include one or more stack poles protruded from the base frame. The height of the stack poles is larger than the height of the folded panel cart, e.g., larger than the thickness of the standing frames so that the stack poles protrude above the folded standing frames for supporting the base frame of the folded panel cart disposed on top of the bottom folded panel cart.

The stack support 907 can include a base, such as a beam on the base frame, on which the stack poles are placed. The base can have enlarged bottom portions, configured to mate with the top portion of the stack poles. For example, in the stacking configuration of two folded panel carts, the stack poles of a bottom folded panel cart can contact the enlarged base bottom portions of a top folded panel cart. The enlarged base bottom portions can have a larger area than the top surface area of the stack poles, to facilitate the placement of the top folded panel cart on the bottom folded panel cart.

The panel cart further includes multiple standing frames 902, such as frames having the shape of letter A, which are positioned perpendicularly on the base frame 901. The standing frames include multiple beams coupled together. For example, as shown, a standing frame can include 2 beams coupled at one end, together with a reinforced bar separating the 2 beams to form a letter A. The end of the legs of the standing frame, e.g., the two bottom potions of the letter A, can be disposed on the base frame, and are recessed from the edges of the width of the base frame. The recesses at both sides of the standing frames are configured to support panels, e.g., the panels can have one edge disposed on the base frame at the recess area, and have the back surface resting on the standing frames. The slanted angles on the sides of the standing frame can assist in securing the panels on the panel carts. In addition, there can be rubber pads on the standing frame to minimize the breakage of the panels.

The standing frames 902 are disposed along a length of the base frame, with outermost standing frames positioned at or near edges of the base frame. For example, there can be 4 standing frames 902 disposed on the base frame 901. The spacing of the standing frames can be the same. Alternatively, the middle two standing frames can have a larger separation as compared to the separation between the middle and the end standing frames. For example, the middle standing frame, such as the second standing frame from the least most standing frame, can be separated a distance from the right most edge of the base frame, with the distance equal to or larger than the height of the standing frame. As such, the middle standing frame can be folded onto the base frame without extending outside the surface defined by the base frame.

At the end of the legs of the standing frame, there can be hinges 902A and couplers 902B. The hinges 902A are configured to allow the standing frame to rotate, e.g., from being upright on the base frame to be parallel to the base frame. The couplers 902B are configured to secure the standing frame to the base frame to support the standing frame to be in the upright position. The couplers can be designed for quick assembling, e.g., securing, and disassembling, e.g., removing. Chains can be used to couple the coupler components, such as bolts, to the frames to prevent the coupler components from getting lost.

Between the standing frames, there can be connector bars 903. The connector bars can be configured to couple two adjacent standing frames, such as connecting two beams of the two adjacent standing frames. As shown, the connector bars 903 are configured to connect the reinforced bars 904 of adjacent standing frames.

The connector bars can be hinged connector bar, e.g., one end of the connector bar is coupled to a reinforced bar by a hinge 903A. The hinge 903A can allow the connector bar to rotate, for example, from a configuration coupling two adjacent standing frames to a position parallel to a standing frame.

The connector bars can include a coupler 903B at an opposite end, e.g., a connector bar 903 has a hinge 903A at one end and a coupler 903B at an opposite end. The coupler is configured to secure the connector bar to the adjacent standing frame, so that the standing frames are secured as a single unit on the base frame.

The number of standing frames can be larger than the number of connector bars, e.g., there can be one standing frame without having a hinged connector bar. For example, as shown, the left and right most standing frames are coupled to the left and right connector bars through a hinge, respectively. The middle right standing frame is coupled to the middle connector bar through a hinge and to the left connector bar through a coupler. The middle left standing frame is coupled to the middle connector bar and the left connector bar through couplers. As such, there is no hinged connector bar coupled to the middle left standing frame.

The reinforced bar 905 can be fixedly coupled between two legs of the A-frame of the standing frame. Alternatively, one standing frame, such as the middle left frame or the middle right frame, can have a rotatable reinforced bar 904. As shown, the reinforced bar of the middle left standing frame is a hinged reinforced bar 904, e.g., a reinforced bar coupled to one leg of the standing frame by a hinge 904A, and coupled to the other leg of the standing frame by a coupler 904B.

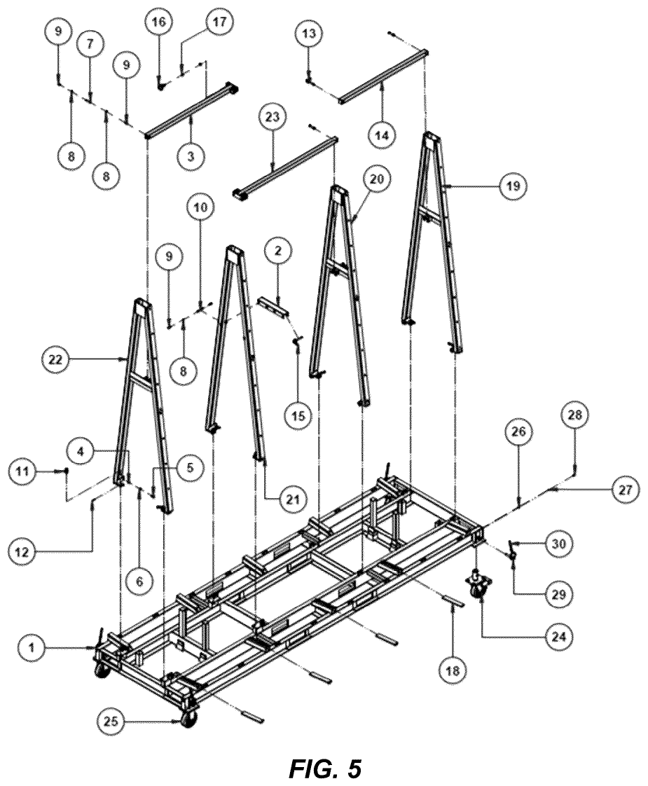

FIG. 5 illustrates an exploded view of a foldable panel cart according to some embodiments. The panel cart includes a base frame 1 having multiple wheels, such as swivel wheels 24 and non swivel wheel 25. The non swivel wheel 25 is shown in assembled configuration, e.g., the non swivel wheel 25 is assembled to the base frame 1. The swivel wheel 24 is shown in exploded configuration, with pin 26, washer 27, and nut 28 for securing the wheel to the base frame. Also shown are a handle 29 for locking the wheel from rotating, and chain 30 for not losing the assembling components of the wheel. The base frame 1 also includes extender 18, which is configured to enlarge a tilted surface area for supporting more panels.

The panel cart includes multiple standing frames 19, 20, 21, and 22 having A-shape, e.g., A frame. The standing frames are configured to be coupled to the base frame 1, such as rotatably coupled to the base frame at the leg ends of the standing frames.

As shown, a configuration for the standing frames include the right most standing frame 19, the middle right standing frame 20, the middle left standing frame 21, and the left most standing frame 22. The standing frames have a shape of a letter A, e.g., having a left beam coupled to a right beam at the top, with the bottom legs separated a distance. A reinforced bar, such as reinforced bar 2 for the standing frame 21, is disposed between the left and right legs of the A of the standing frame. A standing frame can have the reinforced bars fixedly coupled or rotatably coupled to the legs of the standing frame.

The standing frames are rotatably coupled to the base frame through hinge assemblies with coupler assemblies for securing the standing frames when the standing frames are in an upright configuration. For example, a hinge assembly includes hinge bearing 4, hinge nut 5, and hinge washer 6, which is configured to rotatably couple the leg ends of the standing frame to the base frame. A coupler assembly includes coupler 12 to secure the standing frame to the base frame in the upright position, and handle 11 for hand tightening the coupler 12 for quick securing the standing frame to the base frame.

Connector bars 3, 14, and 23 can be used to connect the standing frames 19, 20, 21, and 22. For example, connector bar 14 connects standing frames 19 and 20. Connector bar 23 connects standing frames 20 and 21. And connector bar 3 connects standing frames 21 and 22. The connector bars are configured to connect the standing frames, e.g., to form an integrated unit to prevent collapsing of individual standing frames.

The connector bars are configured to be foldable, e.g., having a hinge assembly at one end to allow the connector bar to rotate, and a coupler assembly at an opposite end to secure the connector bar to the adjacent standing frame. Since the connector bars are configured to be foldable, a minimum number of connector bars is desirable. As such, the connector bars can be configured to couple the reinforced bars of the standing frames. Other configurations of the connector bars can be used, such as connector bars coupled between leg beams of the standing frames.

A connector bar is coupled between two adjacent standing frames. At one end of the connector bar, a hinge assembly is configured to couple the connector bar with the reinforced bar of one standing frame (of the two adjacent standing frames). At an opposite end of the connector bar, a coupler assembly is configured to couple the connector bar with the reinforced bar of another standing frame (of the two adjacent standing frames). For example, a hinge assembly includes a hinge bar 10, which forms an axis of rotation for the connector bar 3, and hinge washer 8 and hinge nut 9 for securing the hinge bar to a leg of the reinforced bar of the standing frame 22. A coupler assembly includes a coupler bar to secure the connector bar to the reinforced bar, such as coupler bar 13 securing connector bar 14 to the reinforced bar of the standing frame 20. The coupler assembly also includes coupler bolts to secure the connector bar to the reinforced bar, together with coupler handle for hand tightening the coupler for quick securing the connector bar to the reinforced bar. For example, coupler handle 16 and coupler bolt 17 are configured to secure connector bar 3 to the reinforced bar 2 of the standing frame 21.

As shown, the left most 22, the right most 19, and the middle right 20 standing frames have reinforced bars fixedly coupled to the leg beams of the standing frames. The middle left standing frame 21 has a rotatable reinforced bar 2, e.g., a hinged reinforced bar with a hinge assembly coupled to one end of the reinforced bar and a coupler assembly 15 at an opposite end. The hinge assembly includes a hinge bar 10, which forms an axis of rotation for the reinforced bar 2, and hinge washer 8 and hinge nut 9 for securing the hinge bar to a leg of the standing frame.

With the connector bars configured to connect adjacent standing frames, there can be one less connector bar as compared to the number of standing frames. As such, the standing frame without a hinge connector bar can be a middle standing frame, such as the middle left or middle right standing frame in a 4 standing frame configuration.

The middle standing frame without a hinged connector bar can be configured to have the reinforced bar rotatable, e.g., having the reinforced bar connected to one leg of the standing frame by a hinge assembly and connected to the other leg of the standing frame by a coupler assembly. For example, the left most 22, right most 19 and middle right 20 standing frames have the reinforced bars fixedly coupled, such as welded or bolted, to the beam legs of the standing frames. The middle left standing frame 21 has a rotatable reinforced bar 2, e.g., a hinged reinforced bar with a hinge assembly coupled to one end of the reinforced bar and a coupler assembly 15 at an opposite end. The hinge assembly includes a hinge bar 10, which forms an axis of rotation for the reinforced bar 2, and hinge washer 8 and hinge nut 9 for securing the hinge bar to a leg of the standing frame.

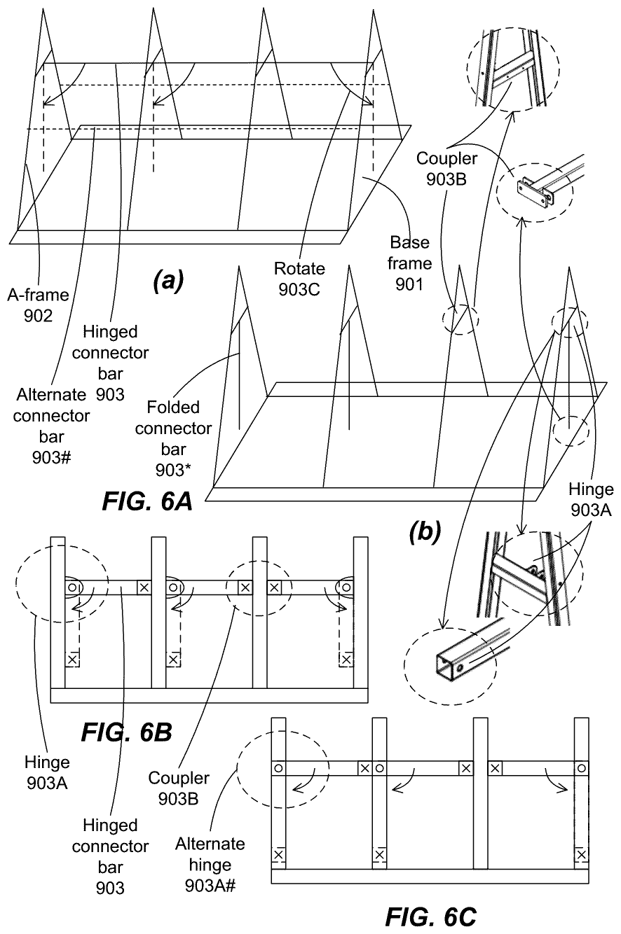

FIGS. 6A-6C illustrate a folding operation of connector bars in a foldable panel cart according to some embodiments. To fold the panel cart, the standing frames, such as standing frame in the form of A-frame 902, are folded from a direction perpendicular to the base frame 901 to a direction parallel to the base frame. Before the standing frames can be folded, the connector bars 903 are first folded, e.g., to release the connection between the standing frames, which can allow the standing frames to be folded.

FIGS. 6A(a) and 6A(b) show a folding process for the connector bar. To be foldable, the connector bars 903 are hinged, e.g., one end of the connector bar is coupled to the standing frame, such as to the reinforced bar of the standing frame, through a hinge. The hinge is configured to allow the connector bar to rotate from a position parallel to the base frame to a position parallel to the standing frame. Other configurations can be used, such as removable couplers at both ends of the connector bar, the connector bar is disposed in a direction not parallel to the base frame, or the connector bar is coupled to the standing frames at locations other than at the reinforced bar. For example, an alternate connector bar configuration 903 #can be used, which connects the legs of two adjacent standing frames.

The hinge for the connector bar can include two parallel flanges welded to the reinforced bar of a standing frame. The flanges have a hole passing through. The hinged connector bar can include a mating hole passing through. In operation, the hinged connector bar can be positioned between the two flanges. A hinge rod can pass through the flanges and the hinged connector bar, e.g., through the holes on the flanges and on the connector bar. The hinge rod can be secured by nuts and washers at both sides. Other hinge configurations can be used, but since there is minimum load on the hinge, simple hinges can be used.

The other end of the connector bar is coupled to the adjacent standing frame by a coupler, which can secure the connector bar to the adjacent standing frame. The coupler can include bolts or nuts, with mating components on the connector bar and on the standing frame. The coupler can be a quick coupler, which is configured to perform a quick connection or a quick disconnection. The coupler can be coupled to the connector bar or to the standing frame, such as a chain, to prevent losing. For example, taping holes can be provided on the reinforced bar of the standing frame, which is mated with flanges on an end of the connector bar. Bolts can be used to secure the connector bar to the reinforced bar.

The connector bars can be hinged to the standing frames, with one standing frame without the hinged connector bar. The standing frame without the connector bar can be a middle standing frame, such as middle left or a middle right standing frame in a 4 standing frame configuration.

FIGS. 6B and 6C show configurations for rotatable connector bars. In FIG. 6B, the connector bar can be coupled to flanges protruded from the legs of the standing frames and from the plane formed by the In FIG. 6B, the connector bar can be coupled to flanges protruded from the legs of the standing frames. Thus, the connector bars can be folded on top of the standing frame. FIG. 6C shows an alternate hinge 903A #, in which the connector bar can be coupled to flanges protruded from the legs of the standing frames but still in within the plane of the standing frame. Thus, the connector bars can be folded to be in a same plane of the standing frame.

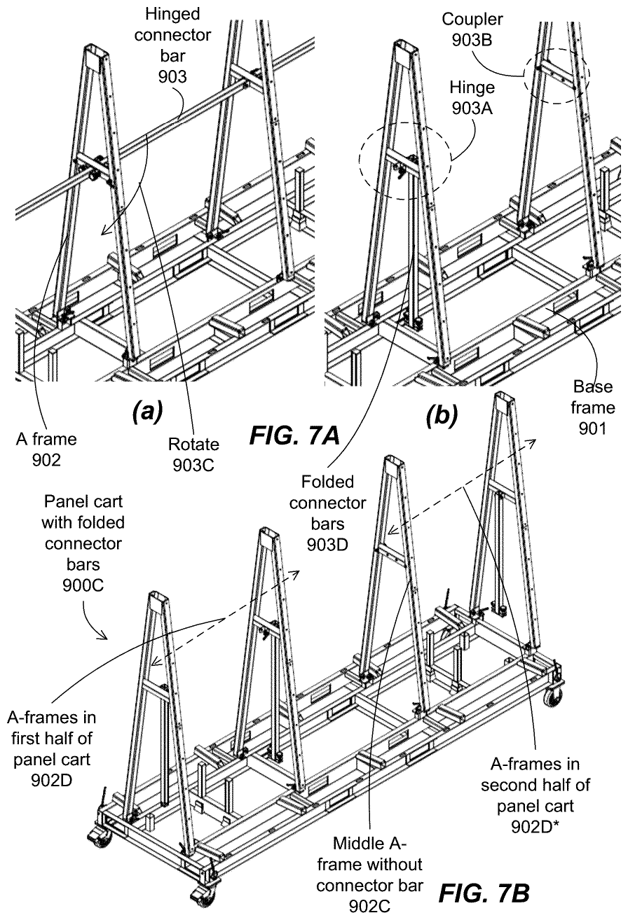

FIGS. 7A-7B illustrate configurations of connector bars in a foldable panel cart according to some embodiments. FIGS. 7A(a) and 7A(b) show a folding process of a connector bar 903 disposed between two A-frame standing frames 902 on a base frame 901. A hinge 903A and a coupler 903B are coupled to two opposite ends of the connector bar 903. After disassembling the coupler 903B, such as removing bolts securing the connector bar to the reinforced bar of the right A-frame, the connector bar can be folded, e.g., rotate 903C, to be parallel with the A-frame.

FIG. 7B shows a panel cart with folded connector bars. The standing frames can be separated into two groups. A left group 902D includes standing frames in a first half of the panel cart. The connector bars in this group are folded to the right, e.g., with the folded connector bars facing the other group. A right group 902D* includes standing frames in a second half of the panel cart. The connector bars in this group are folded to the left, e.g., also with the folded connector bars facing the other group. There can be a standing frame 902C without the connector bar, which can be on the far right of the left group, or as shown, on the far left of the right group.

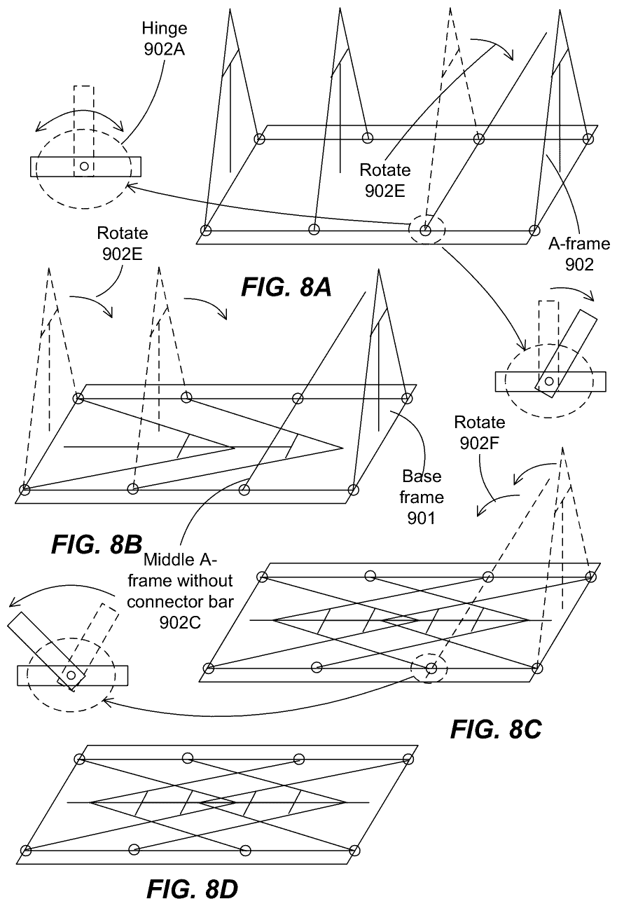

FIGS. 8A-8D illustrate a folding operation of standing frames in a foldable panel cart according to some embodiments. A first group of standing frames, plus one or more additional frames in a second group can be rotated in a direction toward the remaining group. The standing frames in the first group can be further folded to be parallel to the base frame, with the one or more additional frames not folded. The remaining second group of standing frames, including the one or more standing frames, can be folded in an opposite direction, e.g., in the directed toward the folded first group of standing frames. The one or more standing frames are chosen to allow the folding of the standing frames in the first group, e.g., so that the reinforced bars in the one or more standing frames not blocking the folding of the standing frames.

In FIG. 8A, a middle right standing frame, indicated by the dashed line, is rotated 902E to the right, e.g., to the far right standing frame. The hinges 902A coupling the legs of this standing frame to the base frame are configured to allow the standing frame to be rotated in both directions, e.g., to the right and to the left. Other standing frames can be configured to be rotated in only one direction of folding. Further, this standing frame is configured to be the standing frame 902C without the folded connector bar.

In FIG. 8B, the middle left and the left standing frames are rotated 902E, e.g., in the same rotating direction as the middle right standing frame, until the standing frames are parallel to the base frame 901. The earlier rotated standing frame, e.g., the standing frame 902C, is rotated far enough to the right to clear the reinforced bar of the standing frame 902C, e.g., to allow the middle left standing frame to be folded pass the middle right standing frame without the reinforced bar standing in the way. Further, since the standing frame 902C is without the folded connector bar, the left and middle left standing frames can be folded pass the middle right standing frame.

In FIG. 8C, the middle right and the right standing frames are rotated 902F, which is in an opposite rotating direction 902E of the left and middle left standing frames, until the standing frames are parallel to the base frame 901.

In FIG. 8D, the standing frames are shown folded parallel to the base frame.

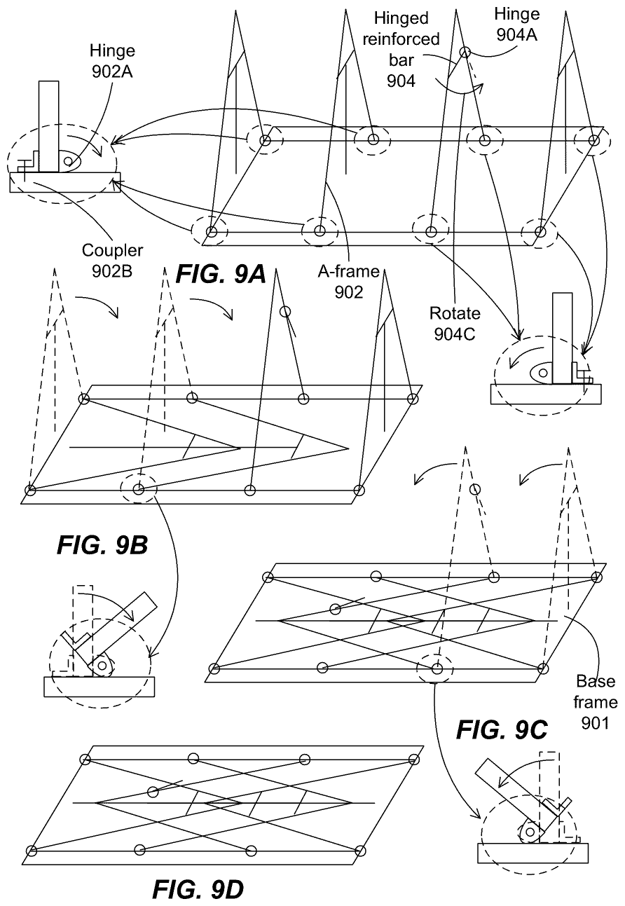

FIGS. 9A-9D illustrate another folding operation of standing frames in a foldable panel cart according to some embodiments. A reinforced bar of a middle standing frame, which is the closest standing frame to a first group of standing frames, is folded to clear the way for folding process of the first group. The remaining second group of standing frames, including the standing frame with the folded reinforced bar, can be folded in an opposite direction, e.g., in the directed toward the folded first group of standing frames. The folding of the reinforced bar is configured to allow the folding of the standing frames in the first group, e.g., so that the reinforced bar does not blocking the folding of the standing frames.

In FIG. 9A, the reinforced bar 904 of a middle right standing frame is rotated 904C to the right, e.g., to the far right leg of the standing frame. A hinges 904A is coupled to the reinforced bar 904 and to the leg of this standing frame, to allow the reinforced bar to be rotated, for example, to be parallel to the leg.

In FIG. 9B, the middle left and the left standing frames are rotated until the standing frames are parallel to the base frame 901. The reinforced bar of the middle right standing frame is already folded to allow the middle left standing frame to be folded pass the middle right standing frame without the reinforced bar standing in the way. The standing frames can be configured to be rotated in only one direction of folding. For example, a hinge 902A can be coupled to one side of the leg of the standing frame, with the opposite side having a flange for securing the standing frame. As such, the standing frame can only be rotate in one direction.

In FIG. 9C, the middle right and the right standing frames are rotated, which is in an opposite rotating direction of the left and middle left standing frames, until the standing frames are parallel to the base frame 901.

In FIG. 9D, the standing frames are shown folded parallel to the base frame.

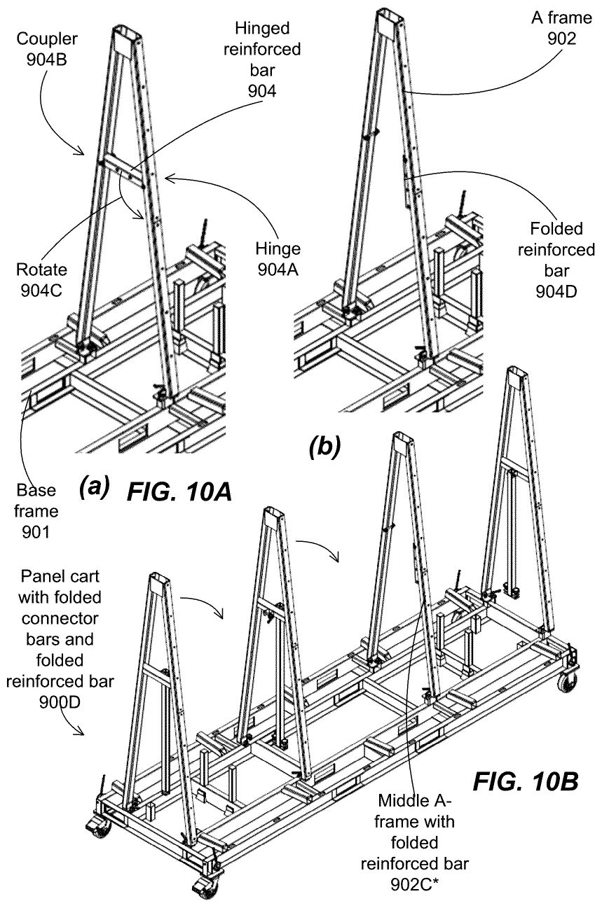

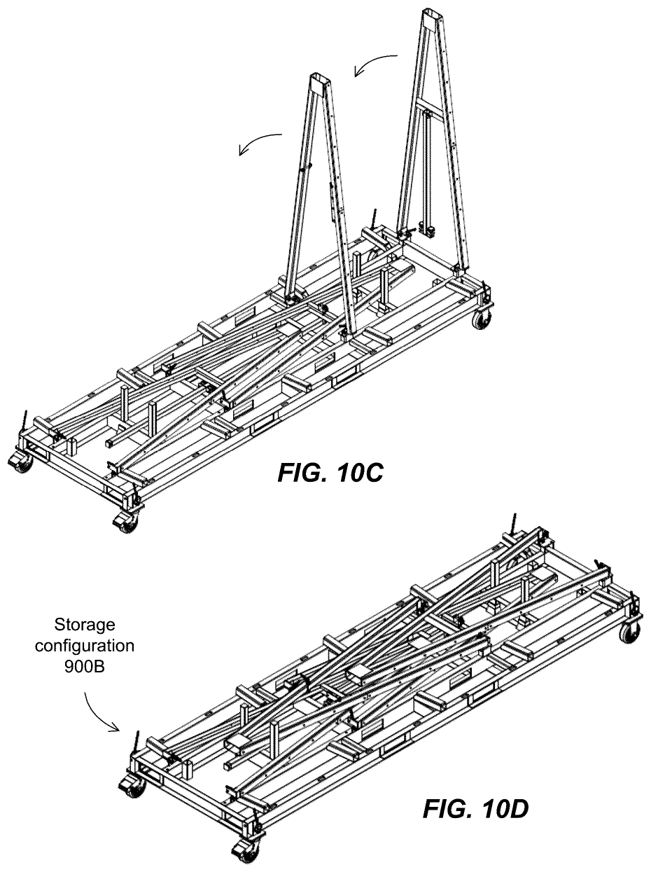

FIGS. 10A-10D illustrate configurations of a reinforced bar in a foldable panel cart according to some embodiments. FIGS. 10A(a) and 10A(b) show a folding process of a reinforced bar 904 disposed in an A-frame standing frame 902 on a base frame 901. A hinge 904A and a coupler 904B are coupled to two opposite ends of the reinforced bar 904. After disassembling the coupler 904B, such as removing bolts securing the reinforced bar to a leg of the A-frame, the reinforced bar can be folded, e.g., rotate 904C, to be parallel with the leg of the A-frame to form the folded reinforced bar 904D.

FIG. 10B shows a panel cart with a folded reinforced bar. The standing frames can be separated into two groups. A left group includes standing frames in a first half of the panel cart with the connector bars folded. A right group includes standing frames in a second half of the panel cart, also with the connector bars folded. There can be a standing frame 902C*, e.g., a standing frame without a connector bar, with the reinforced bar folded. The standing frame 902C* can be on the middle right of the standing frames, or on the far left of the right group as shown.

FIG. 10C shows a panel cart with the left half of the standing frames folded and the right half is ready to be folded. FIG. 10D shows a panel cart with the standing frames all folded.

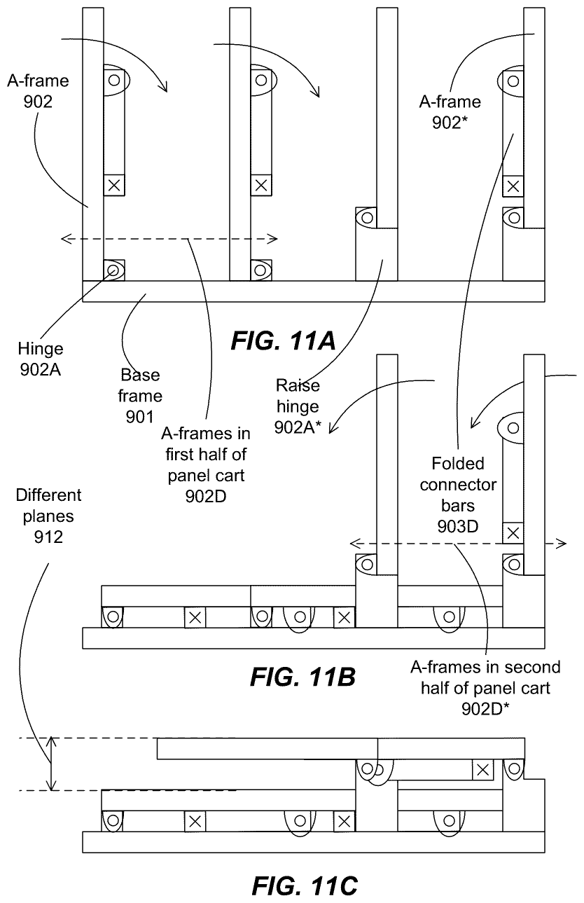

FIGS. 11A-11C illustrate a folding operation of standing frames to form parallel planes according to some embodiments. The folded panel cart can be configured to form parallel planes, instead of angled planes. The parallel planes can provide the folded panel cart with a box-like configuration, e.g., with parallel top and bottom surfaces.

To achieve parallel planes, the left and right groups of standing frames can be configured to be folded into different planes. For example, for folding configuration of the left group being folded first, the right group can be raised higher than the left group, e.g., the hinges on the legs of the right group are disposed on hinged bases taller than the hinges on the legs of the left group.

FIG. 11A shows a side view of a panel cart, including 4 standing frames 902 disposed on a base frame 901. The left group 902D of standing frames, including the left and the middle left standing frames, includes hinges 902A. The right group 902D* of standing frames, including the right and the middle right standing frames, includes hinges 902A*, with the hinges 902A*are raised to be at a higher plane as compared to the hinges 902A. The difference can be configured so that the standing frames in the right group 902D* can be folded on top of the left group 902D without being tilted.

FIG. 11B shows the folded left group of the standing frames. FIG. 11C shows the folded right group of the standing frames, on top of the left group. The difference 912 between the folded planes of the right and left groups is configured so that the right group is folded parallel to the base frame, without being tilted.

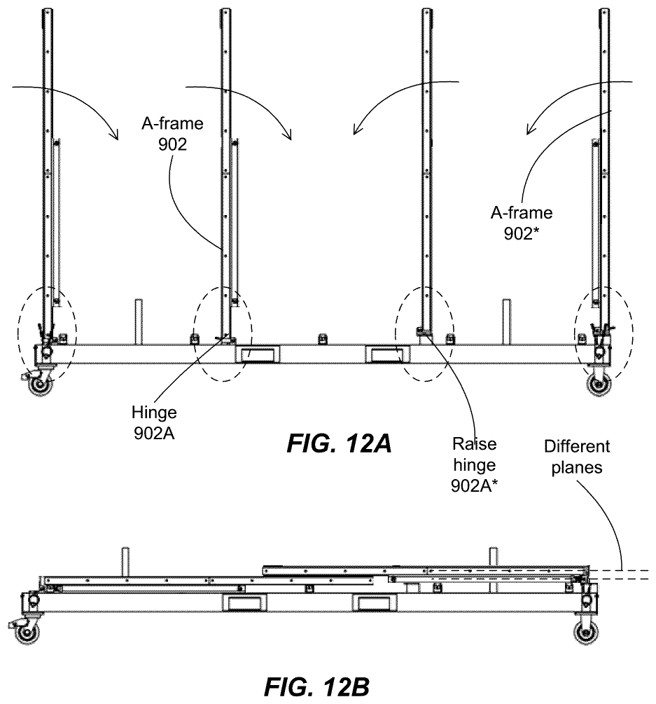

FIGS. 12A-12B illustrate configurations of standing frames folding according to some embodiments. In FIG. 12A, a panel cart can have standing frames 902 erected from a base frame. The right group of the standing frames 902* is coupled to the base frame by raised hinged 902A*, which are disposed at a higher plane as compared to the hinged 902A of the left standing frames 902.

In FIG. 12B, the standing frames are folded, with the right group of standing frames folded at a higher plane than the left group.

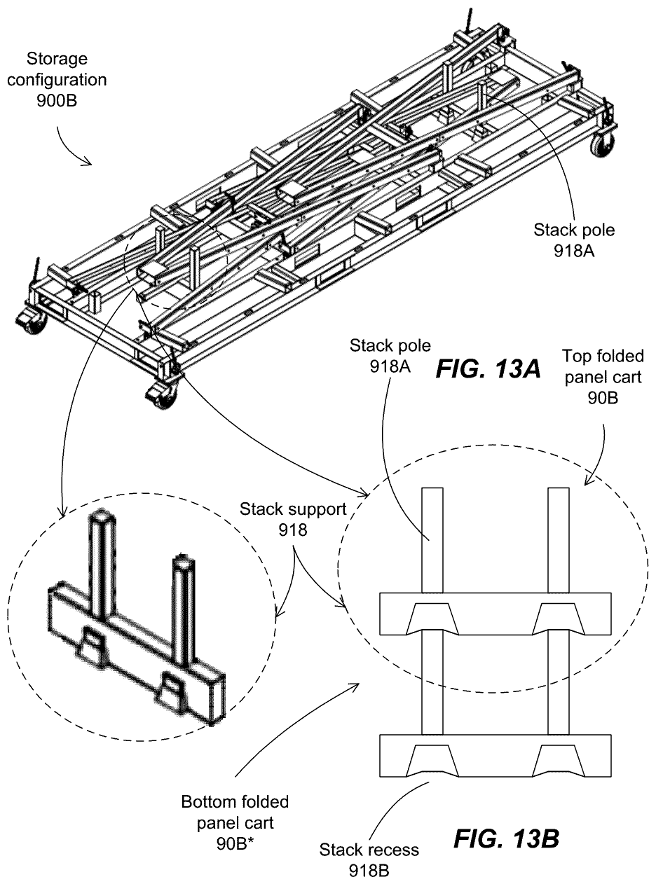

FIGS. 13A-13B illustrate a configuration of a stack support in a base frame according to some embodiments. The folded panel cart can be configured to be stackable, e.g., forming a stack of multiple folded panel carts. Multiple stack supports can be disposed on the base frame of a panel cart, with the stack support configured to support the base frame of a folded panel cart disposed on top of the current folded panel cart.

FIG. 13A shows a folded panel cart in folded configuration 900B. The panel cart includes two stack supports 918 disposed near two ends of the panel cart, with each stack support having 2 stack poles 918A. The stack support 918 can include 2 stack poles 918A, separated be a distance large enough to prevent tilting of the folded panel cart, such as separating a distance larger than a quarter, a third, or a half of the width of the base frame of the panel cart.

The stack support can include a base having a larger bottom than the top end of the stack pole. The larger bottom can include a small recess 918B configured to align the stack poles of a bottom folded panel cart. The height of the stack pole can be high enough to clear the wheels of the top folded panel cart.

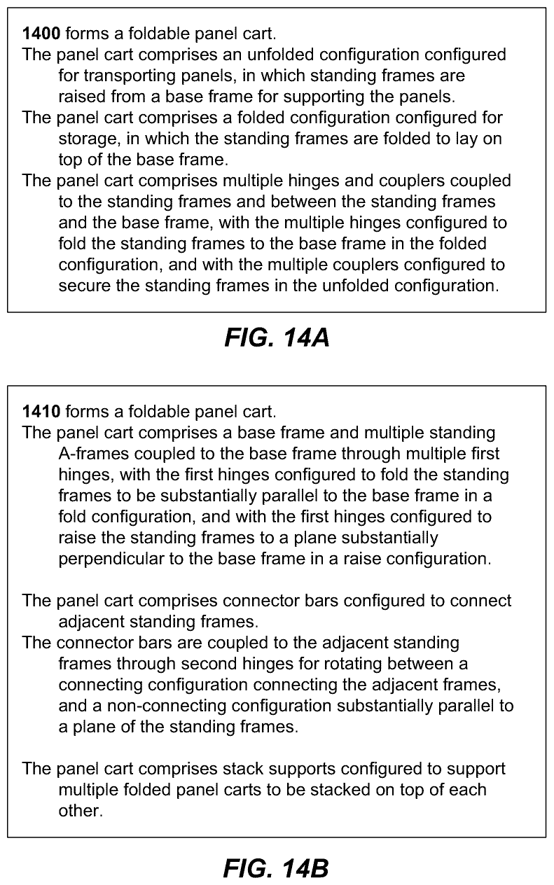

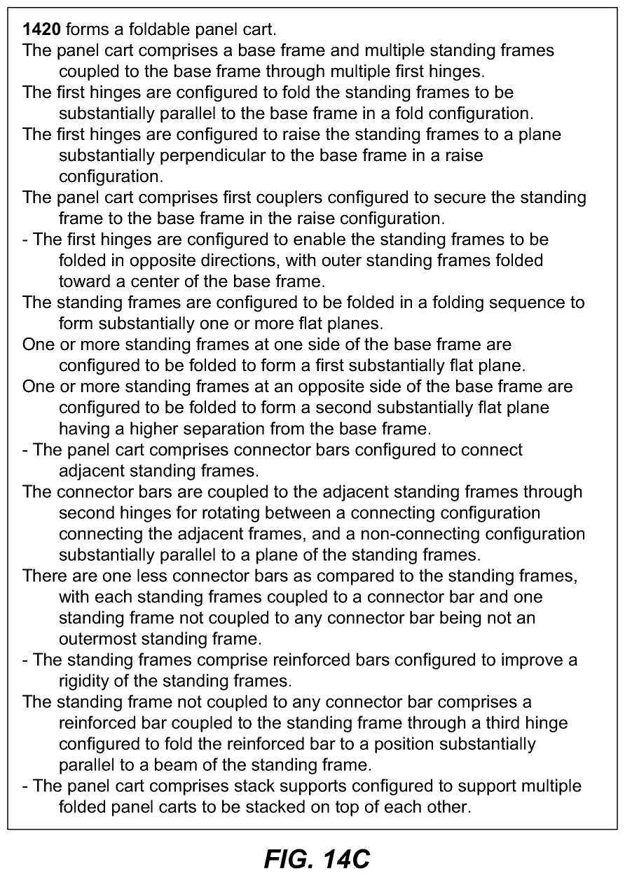

FIGS. 14A-14C illustrate flow charts for forming a foldable panel cart according to some embodiments. In FIG. 14A, operation 1400 forms a foldable panel cart. The panel cart comprises an unfolded configuration configured for transporting panels, in which standing frames are raised from a base frame for supporting the panels.

The panel cart comprises a folded configuration configured for storage, in which the standing frames are folded to lay on top of the base frame.

The panel cart comprises multiple hinges and couplers coupled to the standing frames and between the standing frames and the base frame, with the multiple hinges configured to fold the standing frames to the base frame in the folded configuration, and with the multiple couplers configured to secure the standing frames in the unfolded configuration.

In FIG. 14B, operation 1410 forms a foldable panel cart. The panel cart comprises a base frame and multiple standing A-frames coupled to the base frame through multiple first hinges, with the first hinges configured to fold the standing frames to be substantially parallel to the base frame in a fold configuration, and with the first hinges configured to raise the standing frames to a plane substantially perpendicular to the base frame in a raise configuration.

The panel cart comprises connector bars configured to connect adjacent standing frames.

The connector bars are coupled to the adjacent standing frames through second hinges for rotating between a connecting configuration connecting the adjacent frames, and a non-connecting configuration substantially parallel to a plane of the standing frames.

The panel cart comprises stack supports configured to support multiple folded panel carts to be stacked on top of each other.

In FIG. 14C, operation 1420 forms a foldable panel cart. The panel cart comprises a base frame and multiple standing frames coupled to the base frame through multiple first hinges. The first hinges are configured to fold the standing frames to be substantially parallel to the base frame in a fold configuration. The first hinges are configured to raise the standing frames to a plane substantially perpendicular to the base frame in a raise configuration. The panel cart comprises first couplers configured to secure the standing frame to the base frame in the raise configuration.
The first hinges are configured to enable the standing frames to be folded in opposite directions, with outer standing frames folded toward a center of the base frame. The standing frames are configured to be folded in a folding sequence to form substantially one or more flat planes. One or more standing frames at one side of the base frame are configured to be folded to form a first substantially flat plane. One or more standing frames at an opposite side of the base frame are configured to be folded to form a second substantially flat plane having a higher separation from the base frame.
The panel cart comprises connector bars configured to connect adjacent standing frames. The connector bars are coupled to the adjacent standing frames through second hinges for rotating between a connecting configuration connecting the adjacent frames, and a non-connecting configuration substantially parallel to a plane of the standing frames. There are one less connector bars as compared to the standing frames, with each standing frames coupled to a connector bar and one standing frame not coupled to any connector bar being not an outermost standing frame.
The standing frames comprise reinforced bars configured to improve a rigidity of the standing frames. The standing frame not coupled to any connector bar comprises a reinforced bar coupled to the standing frame through a third hinge configured to fold the reinforced bar to a position substantially parallel to a beam of the standing frame.
The panel cart comprises stack supports configured to support multiple folded panel carts to be stacked on top of each other.

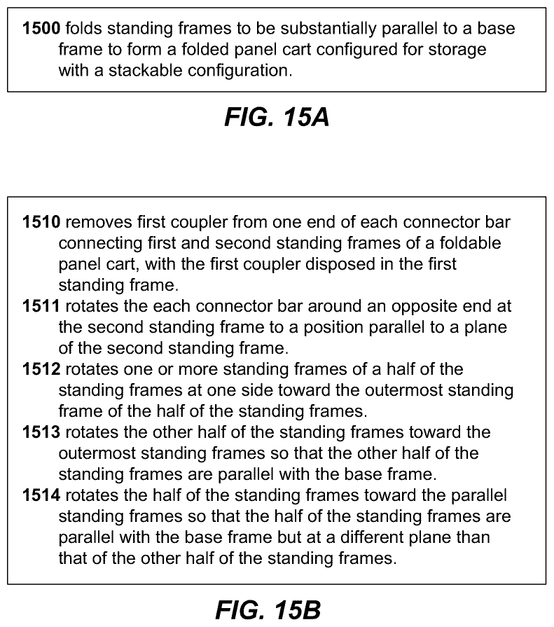

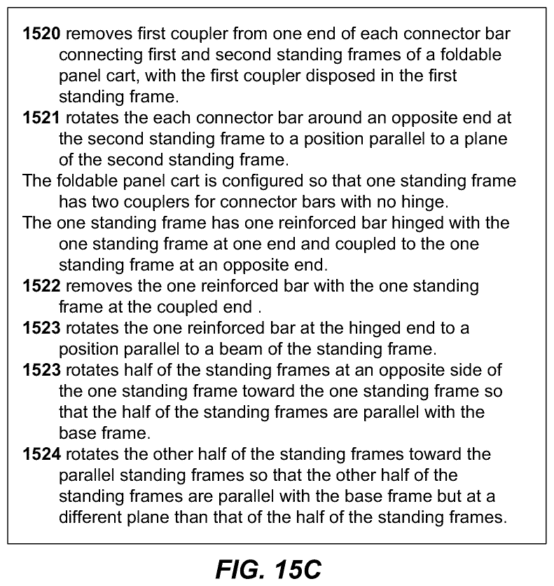

FIGS. 15A-15C illustrate flow charts for folding a foldable panel cart according to some embodiments.

In FIG. 15A, operation 1500 folds standing frames to be substantially parallel to a base frame to form a folded panel cart configured for storage with a stackable configuration.

In FIG. 15B, operation 1510 removes first coupler from one end of each connector bar connecting first and second standing frames of a foldable panel cart, with the first coupler disposed in the first standing frame.

Operation 1511 rotates the each connector bar around an opposite end at the second standing frame to a position parallel to a plane of the second standing frame.

Operation 1512 rotates one or more standing frames of a half of the standing frames at one side toward the outermost standing frame of the half of the standing frames.

Operation 1513 rotates the other half of the standing frames toward the outermost standing frames so that the other half of the standing frames are parallel with the base frame.

Operation 1514 rotates the half of the standing frames toward the parallel standing frames so that the half of the standing frames are parallel with the base frame but at a different plane than that of the other half of the standing frames.

In FIG. 15C, operation 1520 removes first coupler from one end of each connector bar connecting first and second standing frames of a foldable panel cart, with the first coupler disposed in the first standing frame.

Operation 1521 rotates the each connector bar around an opposite end at the second standing frame to a position parallel to a plane of the second standing frame. The foldable panel cart is configured so that one standing frame has two couplers for connector bars with no hinge. The one standing frame has one reinforced bar hinged with the one standing frame at one end and coupled to the one standing frame at an opposite end.

Operation 1522 removes the one reinforced bar with the one standing frame at the coupled end.

Operation 1523 rotates the one reinforced bar at the hinged end to a position parallel to a beam of the standing frame.

Operation 1523 rotates half of the standing frames at an opposite side of the one standing frame toward the one standing frame so that the half of the standing frames are parallel with the base frame.

Operation 1524 rotates the other half of the standing frames toward the parallel standing frames so that the other half of the standing frames are parallel with the base frame but at a different plane than that of the half of the standing frames.

In some embodiments, a collapsible cart is disclosed. The collapsible cart can be used for holding and transporting panels, such as glass panels, wood panels, or granite panels. The collapsible cart can also be collapsed, e.g., folded, to reduce a height of the cart for storage by stacking the carts on top of each other.

The collapsible cart can include a base frame and multiple support frames coupled to the base frame. The coupling of the multiple support frames to the base frame is configured to provide an operating configuration for holding and transporting panels, and a folding configuration for storage stacking.

The base frame can include multiple wheels coupled to a bottom surface of the base frame. The wheels are configured for moving the collapsible cart. For example, the wheels can include swivel wheels 24 and non-swivel wheels 25 (FIG. 2A).

The base frame can include a structure configured for accepting a fork of a fork lift for moving the collapsible cart. For example, a beam of the base frame can have slots 906 (FIG. 2A) which can be large enough for accepting the forks of a fork lift 912 (FIG. 2B).

In the operating configuration, the multiple support frames stand from the base frame. The stand support frames are configured for supporting side surfaces of the panels having edges resting on the base frame.

The support frames can be coupled to the base frame using a rotational mechanism, such as a hinge assembly 902A in FIG. 4, configured for moving the support frames between the operating configuration and the folding configuration. For example, the support frames can rotate between a standing position perpendicular to the base frame surface and a folding position parallel to the base frame surface.

The rotational mechanism can be configured to rotate the support frames at angles up to 90 degrees, e.g., between 0 degree (when the support frames are parallel to the base frame) and 90 degrees (when the support frames are perpendicular to the base frame). For example, a support frame 902 can have a hinge 902A (FIG. 9A) or hinge assembly 4, 5, 6 (FIG. 5) and coupler 902B assembly (FIG. 9A) or coupler 12 and handle 11 (FIG. 5). The support frame 902 can rotate around the hinge 902A, such as between the standing position (FIG. 9A) and the folding position (FIG. 9B). The base frame can function to stop the rotation of the support frame when the support frame rotates to the folding position. The coupler 902B can function to stop the rotation of the support frame when the support frame rotates to the standing position. A secure mechanism including coupler 12 and handle 11 can be used to secure the support frame to the standing position.

The rotational mechanism can be configured to rotate the support frames at angles more than 90 degrees, e.g., at 0 degree when the support frames are parallel to the base frame, at 90 degrees when the support frames are perpendicular to the base frame, and can rotate pass the 90 degree mark to tilt the support frames to an opposite direction. A combination of support frames rotating 90 degrees or less and of support frames rotating more than 90 degrees can be used. For example, there can be one support frame rotatable more than 90 degrees while other support frames rotatable at maximum of 90 degrees.

In the folding configuration, the support frames are folded onto one or more surfaces parallel to a surface of the base frame. For example, some support frames can be folded on a first surface, and some support frames can be folded on a second surface parallel to the first surface and spaced from the first surface. By folding the support frames, the collapsible cart is collapsed, e.g., folded, to have a reduced height suitable for storage by stacking the folded carts on top of each other.

The support frames are configured to be nestable, e.g., folded into a nested volume having a substantially flat top or bottom surface without excessive protrusion, e.g., the protrusion from the flat top or bottom surface is small enough as to not interfere with another support frame nesting to the nested volume or with another support frame folded on top of the nested volume. The nested volume can be within the lateral surface of the base frame, e.g., the folded support frames do not extend beyond the lateral surface of the base frame. Thus, the lateral area of the folded cart is defined by the lateral surface area of the base frame. The nested volume can have a minimum height, e.g., the support frames are folded flat with any protrusion, if existed, not interfere with the folding of other support frames so that the folded cart has a minimum volume for optimal stacking.

The support frames are configured to be nestable, e.g., one frame is disposed in an inner volume of another frame, without or with a minimum protrusion. The support frames can be designed to keep a small protrusion, with the small protrusion does not interfere with the folding of other frames. The nested frames can have a flat top side with some protrusion in a bottom side. Without any protrusion, the nested frames can form a layer with a thickness equal to the thickness of a frame. With protrusions, the nested frames can form a layer with a width larger than the thickness of a frame, e.g., a combination of the frame thickness and the height of the protrusions.

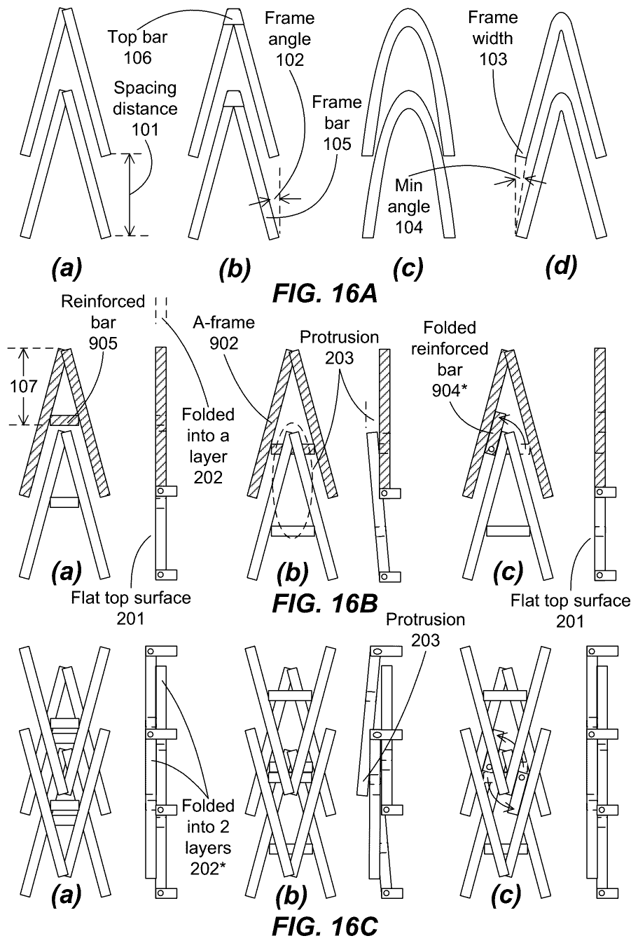

FIGS. 16A-16C illustrate configurations of nestable support frames according to some embodiments. A support frame can include a curved bar or a segmented bar, e.g., two or more segments connected together. The curved or segmented bar can form a nestable open triangle or trapezoid. FIG. 16A(a) shows support frames having two connected segments forming an open triangle. The support frames are spaced from each other a spacing distance 101, which is based on the design consideration of the collapsible cart. For example, the spacing distance between support frames can be small enough to support panels on the base frame, e.g., without the panels falling through the spacing or without the panels being bent between the support frames. The spacing distance between support frames can be large enough to reduce cost, e.g., having a minimum number of support frames. A collapsible cart can have 4 support frames spaced from each other on a base frame. There can be two outer support frames disposed at two opposite edges of the base frame. There can be two inner support frames disposed at equal distances between the outer support frames. In this case, the spacing distance 101 is about a third of the length of the base frame.

The slanted angle 102 of a segment with a line perpendicular to the open base of the triangle is larger than a minimum angle 104 to allow the nesting of multiple frames. The minimum angle 104 is an angle of a triangle with the spacing distance 101 and the frame width 103. Approximately, the minimum angle 104 is an angle having a tangent value of a ratio of the frame width 103 and the spacing distance 101.

FIG. 16A(b) shows support frames having two connected segments having a cap or three connected segments with the middle connected segments different than the other two outer segments. The support frame can be viewed as an open triangle with the top rounded or flattened. The support frame can also be viewed as an open trapezoid, with an open bottom base for case of nesting other support frame, and with a small top base connecting two ends of the two sides of the trapezoid. The slanted angle of the outermost segments, e.g., segments forming the sides of the trapezoid, is larger than the minimum angle 104.

FIG. 16A(c) shows support frames having a curved bar shaping as an open portion of an ellipse. The ellipse shape is configured to allow nesting of multiple support frames.

FIG. 16A(d) shows support frames having two straight segments coupled to a curved section to form a rounded triangle, The angles of the triangle sides is larger than the minimum angle 104 to allow nesting of multiple support frames.

The support frame can include a reinforced bar 905 or a connect bar connecting between segments of the curved bar or the segmented bar of the support frame. The reinforced bar 905 can be connected with the segmented bar at two points, such as at one point each with the two side segments of the triangle formed by the two segmented bar.

FIG. 16B(a) shows support frames nested into each other. A support frame can include two segments, e.g., a segmented bar having two connected segments, and a reinforced bar 905 connecting the two segments to provide rigidity to the support frame. The reinforced bar can be disposed at a distance 107 from the top of the support frame, with the distance 107 less than the spacing distance 101 to allow the nesting of two support frames into a layer 202 having a flat top surface 201. The reinforced bar can be fixedly coupled to the other segments of the support frame.

FIG. 16B(b) shows support frames with reinforced bars disposed at a distance (from the top) larger than the spacing distance 101. The nesting of a second support frame in the inner volume of the first support frame can include a protrusion 203, with the top portion of the second support frame resting on the reinforced bar of the first support frame. The protrusion can be configured to allow the folding of other support frames without excessive total height of the folded cart. The reinforced bar can be fixedly coupled to the other segments of the support frame.

FIG. 16B(c) shows support frames with reinforced bars disposed at a distance (from the top) larger than the spacing distance 101, but the reinforced bar 904* can move out of the way for nesting. For example, the reinforced bar can be coupled to the segments of the frame by a hinge mechanism and a coupler mechanism. The coupler mechanism can allow the reinforced bar to be disengaged or removed from the segment. The hinge mechanism can allow the decoupled reinforced bar to rotate, such as to be parallel to the segment. By rotating out of the original position, the other frame can be nested to the frame with the rotated reinforced bar, with the nested frames forming a flat volume without a protrusion.

FIGS. 16C(a)-16C(c) show nesting configurations of 4 frames, with two sets of two frames nested in two opposite directions. In FIG. 16C(a), the frames are folded into two separate flat layers disposed on top of each other. In FIG. 16C(b), the frames are folded into two separate layers with each layer having a protrusion, and with the top layer accommodate the protrusion of the bottom layer. In FIG. 16C(c), the two middle frames have the reinforced bars decoupled and rotated, before folding into two separate flat layers disposed on top of each other.

To optimize the stacking of the folded carts, some of the support frames are configured to be nested within each other when folded to minimize the combined thickness of the folded support frames.

The support frames can include connector bars 903 coupled between two support frames, such as between two adjacent support frames. The connector bars can be used to secure the support frames in the standing configuration, e.g., to prevent the support frames from being collapsed into the folded configuration.

For example, the support frames can include a rotatable mechanism, such as a hinge assembly 902A, to allow the support frames to rotate between a folded configuration 900B parallel to the base frame and a standing configuration 900A perpendicular to the base frame. The support frame can include a coupler mechanism, such as a block assembly 902B assembled to one side of the leg ends of the support frames. The coupler mechanism can be configured to prevent the support frames from rotating pass the standing configuration, e.g., stopping the support frames at the standing configuration or at an angle 90 degrees from the folding configuration (see FIGS. 9A-9D). The connector bars can provide support for the support frames, preventing the frames from rotating to the folding configuration.

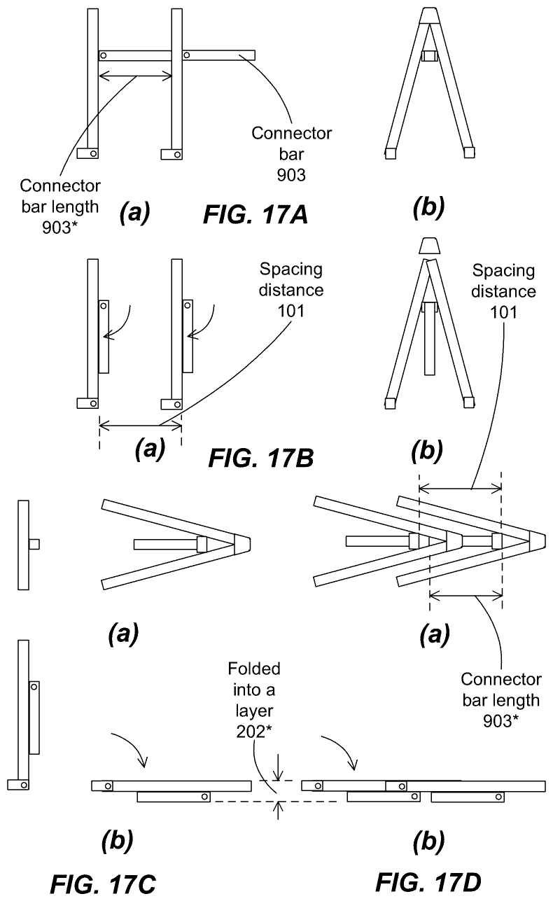

FIGS. 17A-17D illustrate a folding operation for two adjacent support frames according to some embodiments. FIG. 17A(a) shows a front view of two support frames with connector bars 903 coupled to two adjacent support frames, with a support frame not shown. FIG. 17A(b) shows a side view of the two support frames. As shown, the connector bar is coupled to a right support frame with a coupler mechanism, such as a latch or a lockable assembly, to allow the connector bar to decouple or disengaged from the right support frame. The connector bar is coupled to a left support frame with a rotatable mechanism, such as a hinge assembly, to allow the connector bar to rotate, for example, to be parallel to the left support frame. The connector bar can have a length 903*, which is less than the spacing distance 101, for example, by a width or thickness of the support frame The connector length is less than the spacing distance can enable the nesting of the support frames without any protrusion, when the connector bars are folded to be parallel with the support frame surface.

FIGS. 17B(a) and 17B(b) show front view and side view of a configuration in which the connector bars are folded to be parallel with the support frame surfaces. Before folding, the connector bars can be disengaged from the support frames.

FIGS. 17C(a) and 17C(b) show a top view and a side view of a configuration in which a support frame, the right support frame as shown, is folded on a lateral surface of the base frame. The hinge assembly can be configured to allow the right support frame to be folded into a layer 202*.

FIGS. 17D(a) and 17D(b) show a top view and a side view of a configuration in which both support frames are folded on the lateral surface of the base frame. The left support frame can be folded to be nested into the right folded support frame. The support frames can be configured so that the left support frame are nested within the volume formed by the right folded support frame, e.g., into a layer 202*.

The folded support frames are configured to be nested to provide a minimum total thickness for the folded collapsible cart. The minimum total thickness of the folded collapsible cart can include a combined thickness of two folded support frames to be less than twice a thickness of only one folded support frame. Without nesting, the thickness of two folded support frames is about twice the thickness of one folded support frame. Thus, the nesting of the support frames can assist in reducing the thickness of the folded support frames. The thickness of a folded support frame can be twice the thickness of a segment in a segmented bar of the support frame, such as a combination of the thickness of the segmented bar and the thickness of the folded connector bar.

With a complete nesting, the thickness of two folded support frames can be about or comparable with the thickness of a folded support frame. With a partial nesting, the thickness of two folded support frames can be slightly larger than the thickness of a folded support frame, such as 10, 15, 20, 25, or 30% larger. The larger thickness can be due to the protrusion, protruding from the flat surface of the folded support frame.

The support frames can be folded in opposite directions. For example, one or more first support frames, such as support frames on a left side of the base frame, can be folded toward the right side of the base frame to rest on the base frame to form a first layer. One or more second support frames on an opposite side, such as support frames on a right side of the base frame, can be folded toward the left side of the base frame to rest on the base frame to form a second layer on top of the first layer. By folding the support frames in opposite directions, the lateral area of the folded cart can be reduced.

The left and right support frames can be coupled to the base frame at two different lateral surfaces, which is configured to fold the at least two support frames into two different lateral layers, e.g., the first and second layers.

The collapsible cart can include 4 or more support frames, with two or more support frames at a first side of the base frame are nestedly folded in a first direction into a first layer, and with two or more support frames at a second side of the base frame are nestedly folded in a second direction opposite the first direction into a second layer on top of the first layer.

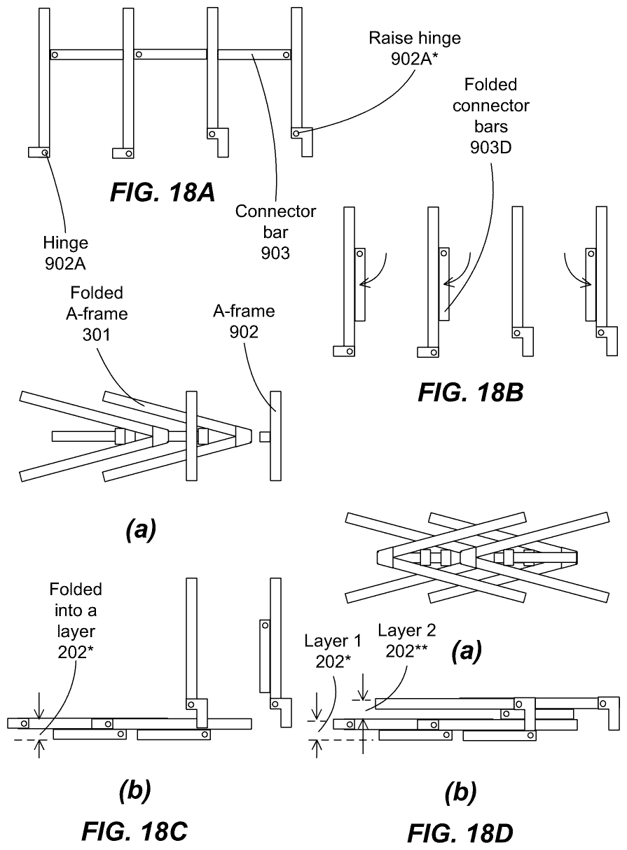

FIGS. 18A-18D illustrate a configuration for nesting 4 support frames of a collapsible cart according to some embodiments. FIG. 18A shows a front view of 4 support frames with 3 connector bars 903 each coupled to two adjacent support frames. The right support frames are coupled to the base frame at raised hinges 902A* at a higher elevation as compared to the hinges 902A for the left support frames.

FIG. 18B shows a front view of a configuration in which the connector bars are folded to be parallel with the support frame surfaces. Before folding, the connector bars can be disengaged from the support frames.

FIGS. 18C(a) and 18C(b) show a top view and a side view of a configuration in which the left support frames are folded on a lateral surface of the base frame. The hinge assembly can be configured to allow the left support frames to be folded into a layer 202*.

FIGS. 18D(a) and 18D(b) show a top view and a side view of a configuration in which both left and right support frames are folded on the lateral surface of the base frame. The right support frames can be folded to be on a layer 202** on top of the layer 202* formed by the folded left folded support frames.

In some embodiments, a collapsible cart can include a base frame, multiple support frames coupled to the base frame, and one or more connecting bars coupled to the multiple support frames. One or more first support frames of the multiple support frames are coupled to the base frame at a first side of the base frame and at a first lateral surface of the base frame. One or more second support frames of the multiple support frames are coupled to the base frame at a second side of the base frame and at a second lateral surface of the base frame. The second side is opposite to the first side. The second lateral surface is separated from the first lateral surface by a separation distance perpendicular to the lateral surface.

The coupling of the multiple support frames to the base frame is configured to rotate the multiple support frames between a first configuration and a second configuration. In the first configuration, the multiple support frames stand from the base frame, with the multiple stand support frames configured for supporting panels disposed on the base frame. In the second configuration, the multiple support frames are folded on the base frame, with the one or more first and second support frames folded into separate layers.

The coupling of a first support frame of the one or more first support frames to the base frame is configured to rotate the first support frame from the first configuration to the second configuration in a first direction toward the second side.

The coupling of the first support frame to the base frame is configured to restrict the first support frame from rotating pass the first configuration in a second direction opposite the first direction.

The coupling of a second support frame of the one or more second support frames to the base frame is configured to rotate the second support frame from the first configuration to the second configuration in the second direction.

The coupling of the second support frame to the base frame is configured to restrict the second support frame from rotating pass the first configuration in the first direction.

A connecting bar of the one or more connecting bars is coupled to two support frames of the multiple frames, with the coupled connecting bar configured to restrict rotational movements of the two support frames in the first configuration. One or more connecting bars are configured to be repositionable to enable rotating the multiple support frames from the first configuration to the second configuration, and to enable folding of the multiple support frames into the separate layers.

In some embodiments, a method for preparing a collapsible cart for storage includes decoupling each of the one or more connecting bars from at least one of the two support frames, repositioning the each of the one or more connecting bars, and folding the multiple support frames into two separate layers on the base frame, with one or more first support frame from a first side of the base frame folded in a first direction toward a second side of the base frame opposite to the first side into a first layer of the two separate layers, and with one or more second support frame from the second side of the base frame folded in a second direction toward the first side of the base frame into a second layer of the two separate layers.

The collapsible cart with the folded support frames is configured to be stacked either above or below another folded collapsible cart with an alignment pole in the collapsible cart aligned to an alignment recess in the another folded collapsible cart disposed above, or with an alignment recess in the collapsible cart aligned to an alignment pole in the another folded collapsible cart disposed below.

### GENERAL DISCLAIMER

For convenience, “top”, “bottom”, “above”, “below” and similar descriptors are used merely as points of reference in the description, and while corresponding to the general orientation of the illustrated system during operation, are not to be construed to limit the orientation of the system during operation or otherwise.

When a term such as “about”, “approximately”, or “substantial” is applied to a particular value, e.g. “about perpendicular” or “substantially parallel”, the value, according to the present specification, is interpreted as having less than 20%, less than 10%, less than 5%, or less than 2%, of the value.

What is claimed is:

1. A collapsible cart comprising:
a base frame,
multiple support frames coupled to the base frame,
wherein the coupling of the multiple support frames to the base frame is configured to provide first and second configurations between the multiple support frames and the base frame,
wherein in the first configuration, the multiple support frames stand from the base frame, with the multiple stand support frames configured for supporting panels disposed on the base frame,
wherein in the second configuration, the multiple support frames are folded on one or more surfaces parallel to a surface of the base frame, with the multiple folded support frames configured for reducing a height of the collapsible cart for storage,
wherein at least two support frames of the multiple support frames are configured to be nested within each other when folded to minimize a total thickness of the collapsible cart in the second configuration.

2. A collapsible cart as in claim 1,
wherein the base frame comprises a structure configured for accepting a fork of a fork lift for moving the collapsible cart.

3. A collapsible cart as in claim 1,
wherein a support frame of the multiple support frames is coupled to the base frame using a hinge mechanism configured for moving the support frame between the first and second configurations.

4. A collapsible cart as in claim 1,
wherein a support frame of the multiple support frames is coupled to the base frame using a rotatable mechanism, with the rotatable mechanism configured for rotating the support frame for an angle equal or less than 90 degrees.

5. A collapsible cart as in claim 1,
wherein a support frame of the multiple support frames is coupled to the base frame using a secure mechanism configured for securing the support frame to the first or second configuration.

6. A collapsible cart as in claim 1,
wherein each support frame of the multiple support frames comprises a curved bar or a bar comprising multiple connected segments,
wherein the each support frame further comprises a connect bar connecting the curved or segmented bar at two separate points,
wherein the curved or segmented bar with the connect bar are configured to form a nestable triangle or trapezoid having rounded or sharp angle corners.

7. A collapsible cart as in claim 1,
wherein each support frame of the multiple support frames comprises a curved bar or a bar comprising multiple connected segments,
wherein the curved or segmented bar are configured to form a nestable triangle or trapezoid having rounded or sharp angle corners,
wherein at least a support frame comprises a connect bar coupled to the curved or segmented bar of the support frame at two separate points,
wherein the coupling of the connect bar with the curved or segmented bar is configured to be decouplable at least at one point of the two separate points.

8. A collapsible cart as in claim 1,
wherein minimizing the total thickness of the collapsible cart in the second configuration comprises a combined thickness of the folded at least two support frames to be less than twice a thickness of either folded support frame of the at least two support frames.

9. A collapsible cart as in claim 1,
wherein minimizing the total thickness of the collapsible cart in the second configuration comprises a combined thickness of the folded at least two support frames to be comparable with a thickness of either folded support frame of the at least two support frames.

10. A collapsible cart as in claim 1,
wherein the at least two support frames are configured so that the at least two support frames, when folded, are completely nested in each other with the combined thickness equaled to the thickness of one folded support frame.

11. A collapsible cart as in claim 1,
wherein the multiple support frames comprise one or more first support frames and one or more second support frames coupled to two opposite sides of the base frame,
wherein the first and second one or more support frames are folded in opposite directions.

12. A collapsible cart as in claim 1,
wherein at least two support frames of the multiple support frames are coupled to the base frame at two different lateral surfaces,
wherein coupling at the two different lateral surface is configured to fold the at least two support frames into two different lateral layers.

13. A collapsible cart as in claim 1,
wherein the multiple support frames comprise 4 or more support frames,
wherein two or more support frames at a first side of the base frame are nestedly folded in a first direction into a first layer,
wherein two or more support frames at a second side of the base frame are nestedly folded in a second direction opposite the first direction into a second layer on top of the first layer.

14. A collapsible cart as in claim 1, further comprising
a stack mechanism coupled to the base frame,
wherein the stack mechanism comprises a top element and a bottom element,
wherein the top element of a first collapsible cart is configured to be mated with the bottom element of a second collapsible cart when the second collapsible cart is stacked on the first collapsible cart.

15. A collapsible cart as in claim 1, further comprising
one or more connecting bars,
wherein a connecting bar of the one or more connecting bars are coupled to two adjacent support frames at two different points,
wherein the coupling of the connecting bar with the two adjacent support frames is configured to be decouplable at least at one point of the two different points.

16. A collapsible cart comprising
a base frame,
multiple support frames coupled to the base frame,
wherein one or more first support frames of the multiple support frames are coupled to the base frame at a first side of the base frame and at a first lateral surface of the base frame,
wherein one or more second support frames of the multiple support frames are coupled to the base frame at a second side of the base frame and at a second lateral surface of the base frame,
wherein the second side is opposite to the first side,
wherein the second lateral surface is separated from the first lateral surface by a separation distance perpendicular to the lateral surface,
wherein the coupling of the multiple support frames to the base frame is configured to rotate the multiple support frames between a first configuration and a second configuration,
wherein in the first configuration, the multiple support frames stand from the base frame, with the multiple stand support frames configured for supporting panels disposed on the base frame,
wherein in the second configuration, the multiple support frames are folded on the base frame, with the one or more first and second support frames folded into separate layers,
wherein the coupling of a first support frame of the one or more first support frames to the base frame is configured to rotate the first support frame from the first configuration to the second configuration in a first direction toward the second side,
wherein the coupling of the first support frame to the base frame is configured to restrict the first support frame from rotating pass the first configuration in a second direction opposite the first direction,
wherein the coupling of a second support frame of the one or more second support frames to the base frame is configured to rotate the second support frame from the first configuration to the second configuration in the second direction,
wherein the coupling of the second support frame to the base frame is configured to restrict the second support frame from rotating pass the first configuration in the first direction,
one or more connecting bars coupled to the multiple support frames,
wherein a connecting bar of the one or more connecting bars is coupled to two support frames of the multiple frames, with the coupled connecting bar configured to restrict rotational movements of the two support frames in the first configuration,
wherein the one or more connecting bars are configured to be repositionable to enable rotating the multiple support frames from the first configuration to the second configuration, and to enable folding of the multiple support frames into the separate layers.

17. A collapsible cart as in claim 16,
wherein each support frame of the multiple support frames comprises a curved bar or a bar comprising multiple connected segments,
wherein the each support frame further comprises a connect bar coupled to the curved or segmented bar at two separate points,
wherein the curved or segmented bar with the connect bar are configured to form a nestable triangle or trapezoid having rounded or sharp angle corners,
wherein the coupling of the connect bar with the curved or segmented bar of at least a support frame is configured to be decouplable at least at one point of the two separate points on the curved or segmented bar of the at least a support frame.

18. A collapsible cart as in claim 16,
wherein each support frame of the multiple support frames comprises a curved bar or a bar comprising multiple connected segments,
wherein repositioning of the connecting bar comprises rotating the connecting bar to be parallel with a plane formed by the curved or segmented bar of one of the two support frames,
wherein the connecting bar comprises a length configured to enable nesting the one of the two support frames to another support frame.

19. A collapsible cart as in claim 16,
wherein the one or more first support frames comprise two or more support frames,
wherein the one or more first support frames are nestedly folded into a first layer of the separate layers, with a top surface of the first layer being substantially flat and parallel to the first or second lateral surface of the base frame,
wherein the one or more second support frames are folded into a second layer of the separate layers, with a top surface of the second layer being substantially flat and parallel to the first or second lateral surface of the base frame.

20. A method for preparing a collapsible cart for storage,
wherein the collapsible cart comprises a base frames, multiple support frames coupled to the base frame with the multiple support frames configured to support panels disposed on the base frame, and one or more connecting bars each coupled to two support frames for stabilizing the multiple support frames,
the method comprising
decoupling each of the one or more connecting bars from at least one of the two support frames,
repositioning the each of the one or more connecting bars,
folding the multiple support frames into two separate layers on the base frame, with one or more first support frame from a first side of the base frame folded in a first direction toward a second side of the base frame opposite to the first side into a first layer of the two separate layers, and with one or more second support frame from the second side of the base frame folded in a second direction toward the first side of the base frame into a second layer of the two separate layers,
wherein the collapsible cart with the folded support frames is configured to be stacked either above or below another folded collapsible cart with an alignment pole in the collapsible cart aligned to an alignment recess in the another folded collapsible cart disposed above, or with an alignment recess in the collapsible cart aligned to an alignment pole in the another folded collapsible cart disposed below.
